(19) United States
(12) Patent Application Publication
(10) Pub. No.: US 2025/0230763 A1
(43) Pub. Date: Jul. 17, 2025

(54) HEAT ENGINE THAT CAPTURES AND USES WASTE HEAT TO INCREASE ITS THERMAL EFFICIENCY

(71) Applicant: Emilio Panarella, Ottawa (CA)

(72) Inventor: Emilio Panarella, Ottawa (CA)

(21) Appl. No.: 18/531,686

(22) Filed: Dec. 7, 2023

(51) Int. Cl. F01N 5/02; F02G 5/04

(52) U.S. Cl. CPC F01N 5/02; F02G 5/04

(57) ABSTRACT

A Heat Cyclic Engine operating with the required disclosed thermodynamic parameters and with unidirectional valves that captures and retains the waste heat for increased engine thermal efficiency.

### CROSS-REFERENCE TO RELATED APPLICATIONS

Provisional application No. 63/476,807 filed on Dec. 22, 2022

### STATEMENT REGARDING FEDERALLY SPONSORED RESEARCH OR DEVELOPMENT

### THE NAMES OF THE PARTIES TO A JOINT RESEARCH AGREEMENT:

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

### STATEMENT REGARDING PRIOR DISCLOSURES BY THE INVENTOR OR A JOINT INVENTOR:

### BACKGROUND OF THE INVENTION

### (1) Field of the Invention

### Efficiency of Conversion of Heat to Work

### (2) Description of Related Art Including Information Disclosed Under 37 CFR 1.97 and 1.98

U.S. Pat. No. 10,079,075 B2 dated Sep. 18, 2018 granted to the present Applicant, Emilio Panarella, deals with related art in the specific application of a Nuclear Fusion System. Means for the improvement of the efficiency of conversion of heat to work is disclosed leading to a closer approach to energy breakeven conditions through thermonuclear fusion energy production.

### BRIEF SUMMARY OF THE INVENTION

Increased efficiency of conversion of heat to work in conventional heat engines is obtained through recovery, re-circulation and re-use of waste heat. It is found that most of the waste heat can be recovered, recirculated and re-used if the proper thermodynamics conditions of the operating engine are satisfied. An analysis done through numerical simulation and an experiment done with a model engine both confirm that the increase in the thermal efficiency is limited only by the unavoidable heat losses due to engine material heat conduction. It is found that the efficiency of conversion of heat to work is not limited by the Carnot efficiency, which applies to a cycle where the waste heat is rejected into the outside ambient, but increases to higher thermal efficiency than the Carnot's, because of the recovery, re-circulation and re-use of the waste heat in a cyclic engine. The thermodynamic analysis of the modified cycle disclosed in this invention is done through numerical simulation incorporating the required conditions for higher efficiency, and is also done with a working model engine that provides experimental proof of the attainment of the required conditions for higher efficiency.

### BRIEF DESCRIPTION OF THE SEVERAL VIEWS OF THE DRAWING(S)

FIG. 1 shows a schematic diagram of a conventional heat engine.

FIG. 2 shows the same engine as in FIG. 1 modified according to the present invention in order to allow for both the heat and the fluid transporting the heat to be recovered, re-circulated and re-used within the same cyclic engine.

FIG. 3 shows the model experimental engine used in order to have experimental proof of the engine operation enabled by the present invention.

FIG. 4 shows the details of the modified experimental engine according to the present invention, including the means for recovery, recirculation and re-use of the heat and the fluid transporting the heat.

FIG. 5 shows the model engine while it runs with recovered, re-circulating and re-used heat and the fluid transporting the heat, according to the present invention.

FIG. 6 shows the symbols used in the numerical simulation program (CyclePad) and their definition.

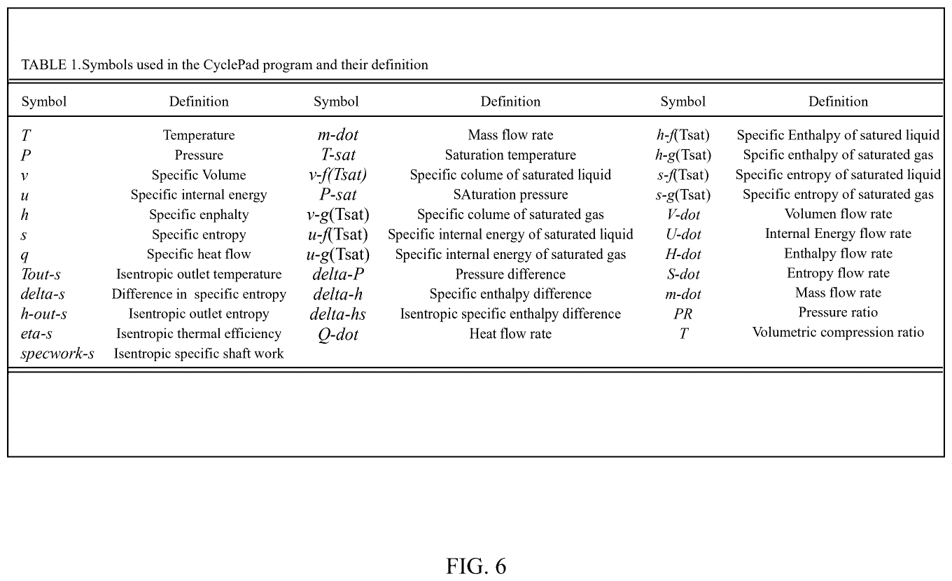

FIG. 7 shows the arrangement of the components, namely: Engine TUR, Unidirectional valve THR1, and Heater HTR, used in the numerical simulation program (CyclePad), as well as the location of the nodes S1, S2, and S3.

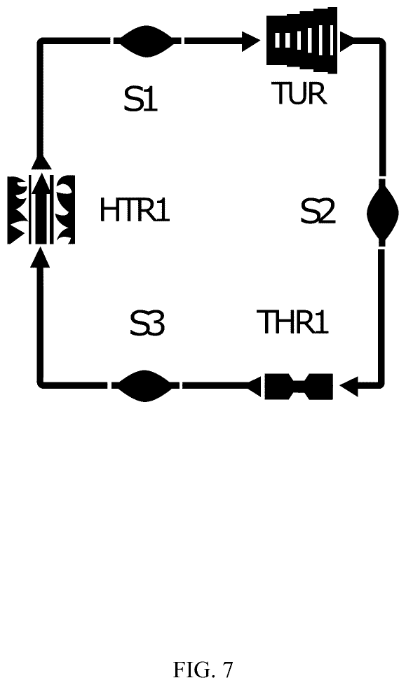

FIG. 8 shows that the fluid used in the analysis has been prescribed to be Water and that its phase is prescribed to be Gaseous at the node S1, as well as the assigned temperature to be T=400 C, the pressure to be P=60 bar, and Fluid flow to be m-dot=1.00 kg/sec. All the other parameters are derived by the numerical program CyclePad.

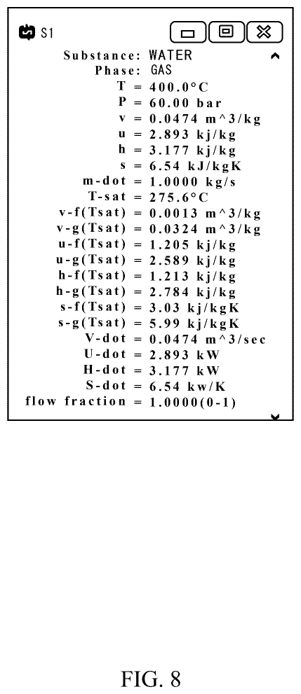

FIG. 9 shows that the temperature T=400 C, and pressure P=60 bar are assigned at the node S2. All other parameters are derived by the numerical program CyclePad.

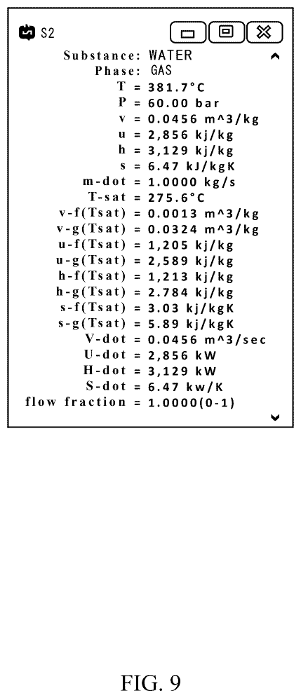

FIG. 10 shows all the parameters at the node S3 derived by the numerical program CyclePad.

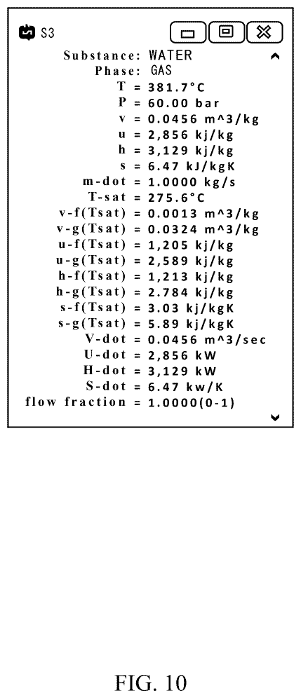

FIG. 11 shows that the engine (Turbine) TUR has been modeled as Adiabatic-Not Isentropic-Not isothermal. The other parameters have been calculated by the numerical program CyclePad.

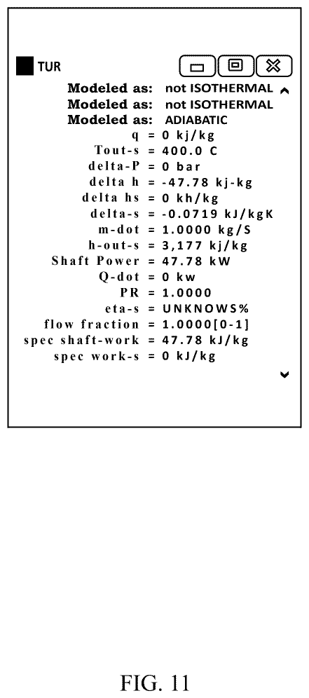

FIG. 12 shows that the Heater (Boiler) HTR1 has been modeled as Isobaric-Not Isochoric. The other parameters have been calculated by the numerical program CyclePad.

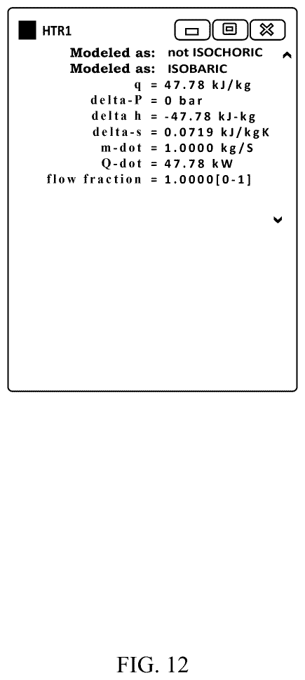

FIG. 13 shows the parameters at the Unidirectional Valve (THR1). calculated by the numerical program CyclePad.

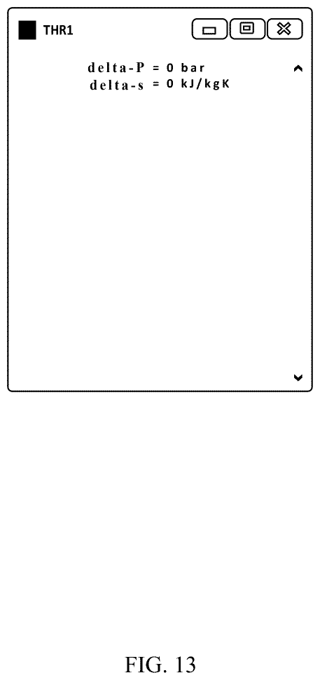

FIG. 14 shows that the Cycle has been modeled as a Heat Engine. All the other parameters have been calculated by the numerical program CyclePad.

### DETAILED DESCRIPTION OF THE INVENTION

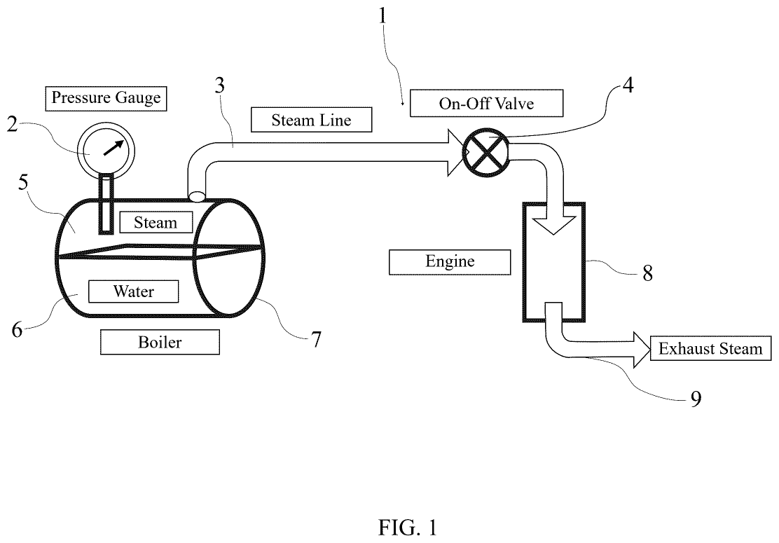

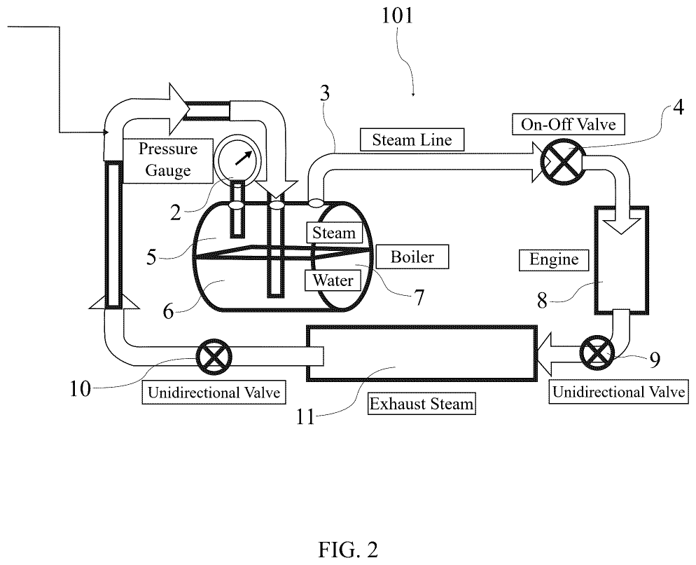

The invention is based on the finding that the Carnot efficiency of a cycling heat engine is not the maximum efficiency of conversion of heat to work that can be obtained from the cycling engine. The Carnot efficiency is the Engine efficiency, which is a function of the temperature drop across the engine. Once the heat leaves the engine, it can be rejected into the ambient, as is presently done (see FIG. 1), or it can be recovered, re-circulated and re-used (See FIG. 2), as disclosed in the present invention. There is indeed a higher efficiency, which is the “thermal efficiency”, that exceeds the Carnot efficiency only if the waste heat can be recovered, re-circulated and re-used. It will be disclosed here the necessary thermodynamic conditions for achieving this objective. The validity of the required thermodynamic conditions will be verified through a numerical simulation program (CyclePad), and a proof-of-principle experiment with a model engine will be reported that discloses the working embodiment of the invented engine.

FIG. 1 shows the components of a conventional engine. It operates between the engine input temperature Tmax (K) and the output temperature Tmin (K). The efficiency of conversion of heat to work for such engine is the Carnot efficiency eta ={1−[Tmin (K)/Tmax (K)]}. For instance, for a heat engine operating between Tmax=400 C=673.15 K and Tmin=381.7 C=654.85 K the Carnot efficiency is: eta=[1−{654.85/673.15)]=2.72%.

The waste heat 9 in a Carnot engine is rejected out of the cycle, and is deposited in the external ambient. This can be done directly and immediately, as shown in FIG. 1, or by means of a heat exchanger that rejects the heat outside the cycle, while retaining the cold fluid for re-circulation with a pump and re-use within the cycle. In either case, the heat crossing the engine is the only heat participating in the conversion of heat to work, and the Carnot efficiency is the correct relation to use for calculating the engine efficiency. There are known means, however, to increase the Carnot efficiency of conversion of the available heat into work. For instance, one can have two engines as in FIG. 1, and arrange them in such a way that the waste heat from the first engine enters the second engine for further conversion of heat into work. Assuming, for example, that the 1^{st} engine has Carnot efficiency equal to 30% and the second engine likewise has 30% efficiency, one finds that the overall efficiency of such combination of two engines one after the other is 51% because 30%+30% of 70% is equal to 51%. This conclusion can obviously be extended and generalized to any number of identical engines, each with efficiency E. The overall efficiency of such a series of n engines becomes Etotal=1−(1−E)\hat{ }n, whose limit is 1 (100% efficiency) for large n.

The present invention deals with only one engine where the waste heat, rather than going into a second, a third, . . . nth engine, is recovered, re-circulated, and re-used, together with the fluid, within the same engine. The required thermodynamic conditions will be disclosed in the present disclosure of invention, where it will be shown that the efficiency of each and every cycle of the invented engine is only limited to being 100% by the unavoidable heat losses due to material heat conduction always present in any engine.

FIG. 2 shows a preferred embodiment of the invention. The waste heat and fluid from engine 8 go now into a chamber 11 through a unidirectional valve 9, and is redirected into the heater (boiler) 7 through another Unidirectional valve 10. The circulation of the fluid carrying the heat is only possible clockwise because of the action of the unidirectional valves 9 and 10 and it is possible only if the fluid pressure is everywhere the same within the closed cycle. These are the thermodynamic conditions required for the engine to be able to recover, re-circulate and re-use the waste heat.

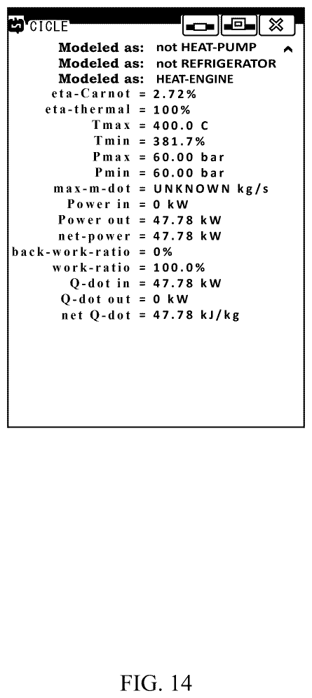

A numerical simulation experiment has been carried out to verify whether recovery, re-circulation and re-use of the heat is possible under the condition of constant pressure within the cycle, and whether the engine is able to deliver some Net Work out of the cycle. The answer is positive on both counts and will be confirmed from the analysis of the numerical results shown in FIG. 14. Here one can see that the cycle operates at constant pressure 60 bar between temperatures Tmax=400 C=673.15 K and Tmin=381.7 C=654.85 K. The Cycle results report that the Carnot efficiency is 2.72%, as expected from the values of the mentioned Tmax and Tmin.

This disclosed constant pressure engine is able to deliver Net Power=47.78 kW corresponding to an Input Heat Power of 47.78 kW, with a Thermal efficiency of 100%.

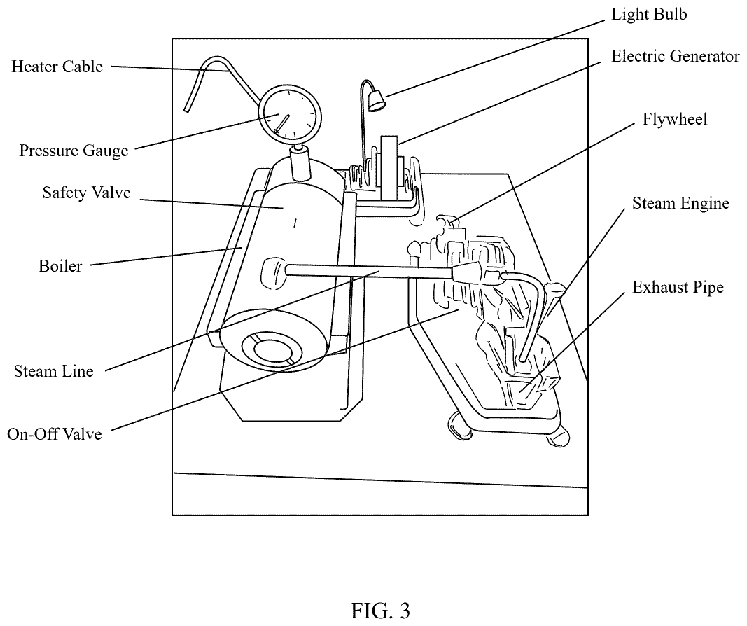

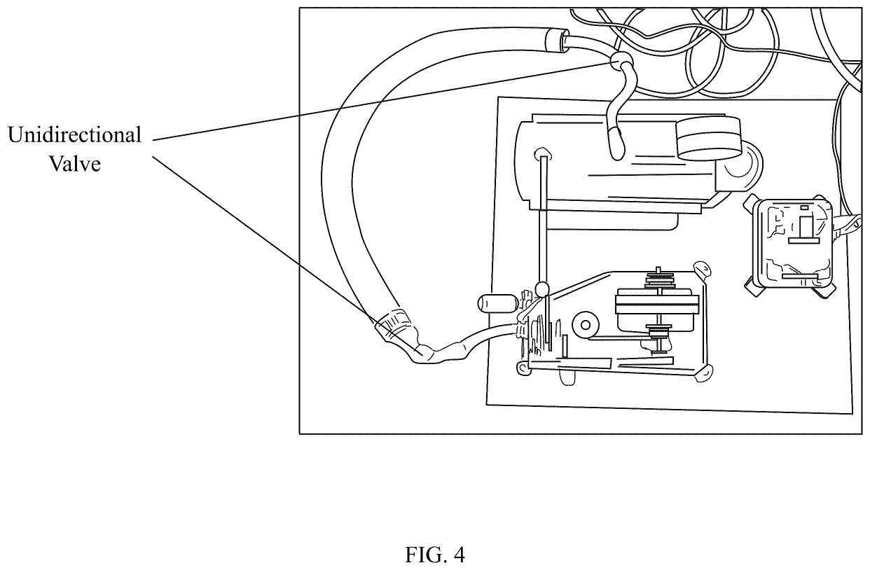

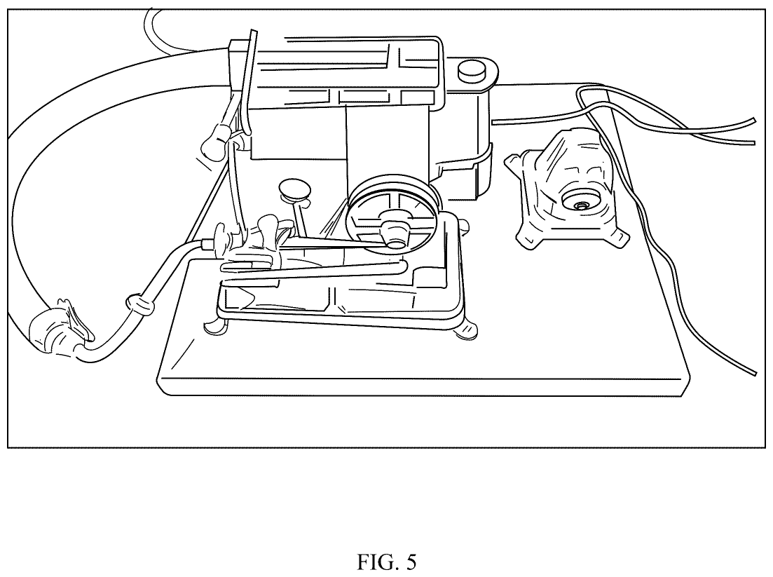

An experiment was carried out with the small-scale operating engine shown in FIG. 3, FIG. 4, and FIG. 5 and the engine ran continuously for 22 minutes with recovered, re-circulated, and re-used heat, as detailed below.

In detail, the apparatus used for the experiment was a Jensen Model 25G miniature steam engine, commercially available. It can safely operate with steam pressure up to 15 psi (1.034 bar), and the water in the boiler is heated with a 400 W electrical heater. A Variac Model No. TDG2-1 KM regulates the 60 Hz AC line current between 0 and 130 V, and a model TM power meter monitors the power in watts used by the water heater. Vinyl tubing (PVC) was used to re-direct the exhausted fluid back into the boiler. The choice of such material was dictated by its low thermal conductivity (0.19 W/m K) relative to metal tubing, such as copper (401 W/m K), thus greatly reducing the heat loss into the surrounding ambient. For reasons that will be disclosed shortly, two different diameter vinyl tubings were used. The central portion of the tubing had length approximately 50 cm and diameter 22.23 mm OD×15.88 mm ID, while the two peripheral parts had diameter 7.94 mm OD×4.76 mm ID, length approximately 10 cm at the exhaust port, and approximately 20 cm at the boiler inlet port. Two Inline Check Valves (Unidirectional Valves) Model YXCC ¼ inch (approximately 6.5 mm) were used to force the flow of the fluid only in one direction, i.e., from the steam exhaust port to the inlet port of the boiler. These two check valves, or unidirectional valves, were positioned: one immediately after the exhaust port, and the other immediately before the boiler inlet port, respectively. They were also made of plastic material. With this arrangement, only the same amount of fluid exiting from the boiler can re-enter into the boiler, and the pressure, at any point of the fluid flow, is constant during operation, thus allowing the engine to operate continuously, as it did.

The use of two different diameter tubings followed the configuration disclosed in U.S. Pat. No. 10,079,075 B2, where it was disclosed that, by providing a large volume for the exhaust steam, the engine can operate for a few cycles before having the fluid pressure increased to the pressure required for the operation at regime.

The engine, as described, was started at 1:12 p.m. EST, when the boiler pressure reached 5 psi (0.344 bar). Shortly after, the pressure decreased to its steady-state operating value of 3.2 psi (0.220 bar). The electrical power remained constant at 349.7 W during operation. The engine operated continuously and smoothly for 22 min, until 1:34 p.m. EST of the same day, thus providing proof of recover, re-circulation, and re-use of the engine waste heat. During this time, a 2 min 10 sec video was run, available in Ref. 3.

### REFERENCES

1. Emilio Panarella, U.S. Pat. No. 10,079,075.
2. Emilio Panarella, Physics Essays 35, 115 (2022).
3. Engine operating with recirculating heat and fluid in proof-of-principle experiment
(https://youtu.be/6XCUFDJsMIw)

The invention claimed is:

1. Heat Cycling Engine comprising an Engine, a Heater and means for a fluid to move in confined space from the Heater to the Engine, so as the Engine can generated Work, where the heated exhaust or waste fluid is recovered at the exit of the Engine and redirected into the Heater through Unidirectional Valves together with the heat carried by it.

2. A Heat Cycling Engine according to claim 1, where the volume per unit length available for the fluid to return from the Engine to the Heater is not constant.
